(19) United States
(12) Patent Application Publication
(10) Pub. No.: US 2012/0169071 A1
(43) Pub. Date: Jul. 5, 2012

(54) MOTORIZED SYSTEM FOR LATCHING AND UNLATCHING CASEMENT WINDOWS

(76) Inventor: André LABARRE, Boucherville (CA)

(21) Appl. No.: 13/422,352

(22) Filed: Mar. 16, 2012

Related U.S. Application Data
(63) Continuation-in-part of application No. 12/428,498, filed on Apr. 23, 2009.

(51) Int. Cl. E05C 1/12

(52) U.S. Cl. 292/143

(57) ABSTRACT

A power-operated latch is integrated to a casement window for selectively locking and unlocking a vertically hinged window sash. The power-operated latch is adapted to be concealed in the window frame and is directly connectable to the existing window latch hardware. A reversible rotary motor drives a lead screw on which a slider is threadably engaged for pivoting a lever connected to a longitudinally movable latch bar.

### RELATED APPLICATION

The present application is a continuation-in-part of U.S. patent application Ser. No. 12/428,498 filed on Apr. 23, 2009 the content of which is incorporated herein by reference.

### TECHNICAL FIELD

The application relates generally to casement windows and, more particularly, to a motorized window latching system.

### BACKGROUND OF THE ART

Casement windows are well known. Such windows typically have one or more window sash pivotable about a vertical axis between an open and a closed position. A latch bar is commonly employed to lock the window sash in its closed position in tight sealing engagement against the window frame. Such latch bars generally include a flat steel strip having various latch points therealong for engagement with corresponding keepers provided along an edge of the associated window sash. The latch bar is typically manually actuated by a pivotable lever or lock handle.

Heretofore, the motorisation of casement window latch mechanisms has been challenging. In most instances, access to the window latch bar is difficult and there is very little room to position the motorized operator. Also the motorized latch operator must not adversely affect the aesthetic of the window in order for the product to gain commercial acceptance.

There is thus a need for a compact motorized latch operator that can be integrated into a casement window without adversely affecting the appearance thereof.

### SUMMARY

It is therefore an object to provide a compact motorized latch operator that can be integrated to a casement window.

In one aspect, there is provided a motorized latch operator adapted to be retrofitted to a normally manually operated latching assembly of a casement window mounted in a building wall, the casement window having at least one window sash hingedly mounted in a casement for pivotal movement about a vertical axis between open and closed positions, keepers being provided along one side of the window sash for engagement with corresponding latches mounted on a vertical side frame member of the casement, the latches being operatively interconnected by a vertical latch bar mounted for longitudinal movement in a gap defined between the side frame member and a moulding member; the motorized operator comprising a support frame mounted in a casing integrated to a building wall next to the casement, a reversible rotary motor hingedly mounted to the support frame, a lead screw drivingly connected to the reversible rotary motor, a slider threadably engaged on the lead screw for movement therealong, a lever pivotally mounted at a first end portion thereof to the support frame, the slider being engaged with the lever to pivot the same in response to a movement of the slider along the lead screw, the lever being pivotally connectable at a second end portion thereof to the vertical latch bar to linearly displace the same when pivoted as a result of the movement of the slider on the lead screw.

In a second aspect, there is provided a power-operated latch assembly for a casement window mounted in a building wall, the casement window having at least one window sash hingedly mounted in a window frame for pivotal movement about a vertical axis between open and closed positions; the power-operated latch assembly comprising at least two keepers mounted to the window sash for locking engagement with corresponding latches operated by a latch bar mounted for vertical movement along one vertical member of the window frame, a reversible operator mounted to a support frame disposed in the building wall adjacent to the casement window, a lever pivotally mounted to the support frame and having a first end drivingly connected to said reversible operator and a second end pivotally connected to the latch bar, the pivotal movement of the lever by the reversible operator causing the linear movement of the latch bar.

In a third aspect, there is provided a casement window comprising at least one window sash hingedly mounted in a window frame for pivotal movement about a vertical axis between open and closed positions, a power-operated latch mechanism for releasably locking the at least one window sash in the closed position, the power-operated latch mechanism comprising at least two keepers mounted to the window sash for locking engagement with corresponding latches operated by a latch bar mounted for vertical movement along one vertical member of the window frame, a reversible rotary motor mounted in one of a cavity defined in the building wall and an internal cavity defined in the window frame, a vertically supported lead screw drivingly connected to the reversible rotary motor, a vertically displaceable slider threadably engaged on the lead screw for linear movement therealong, and a link between the slider and the latch bar, the link transferring the movement communicated to the slider to the latch bar.

Further details of these and other aspects of the present invention will be apparent from the detailed description and figures included below.

### DESCRIPTION OF THE DRAWINGS

Reference is now made to the accompanying figures, in which:

FIG. 1 is a perspective view of a double hung casement type window as seen from inside a room and having a motorized unlatching system mounted inside the central profiled post of the window casement, the front vertical moulding normally covering the central profiled post being omitted to reveal the normally hidden motorized unlatching system;

FIG. 2 is a perspective view of the motorized unlatching system together with the window original latching hardware shown in isolation;

FIG. 3 is a cross-sectional view taken along line 3-3 in FIG. 1;

FIG. 4 is a longitudinal cross-sectional view illustrating the motorized unlatching system in position in the central profiled post of the window casement;

FIG. 5 is a perspective view of another model of double hung casement type window, the vertical moulding along one side of the central post of the window being broken away to show part of a motorized latching system;

FIG. 6 is a vertical cross-sectional view illustrating the details of the motorized latching system of FIG. 5;

FIG. 7 is a perspective view of a single hung casement window, the vertical moulding along one side of the window frame being omitted to reveal details of a motorized latching system connected to the original manual latching system of the window;

FIG. 8 is vertical cross-sectional view illustrating the details of the motorized latching system shown in FIG. 7;

FIG. 9 is a top plan view of a motorized unlatching system in accordance with a further embodiment of the present invention;

FIG. 10 is a cross-sectional view taken along line 10-10 in FIG. 9;

FIG. 11 is a side view of the system shown in FIG. 9, and

FIG. 12 is a cross-sectional view taken along line 12-12 in FIG. 11.

### DETAILED DESCRIPTION OF THE PREFERRED EMBODIMENTS

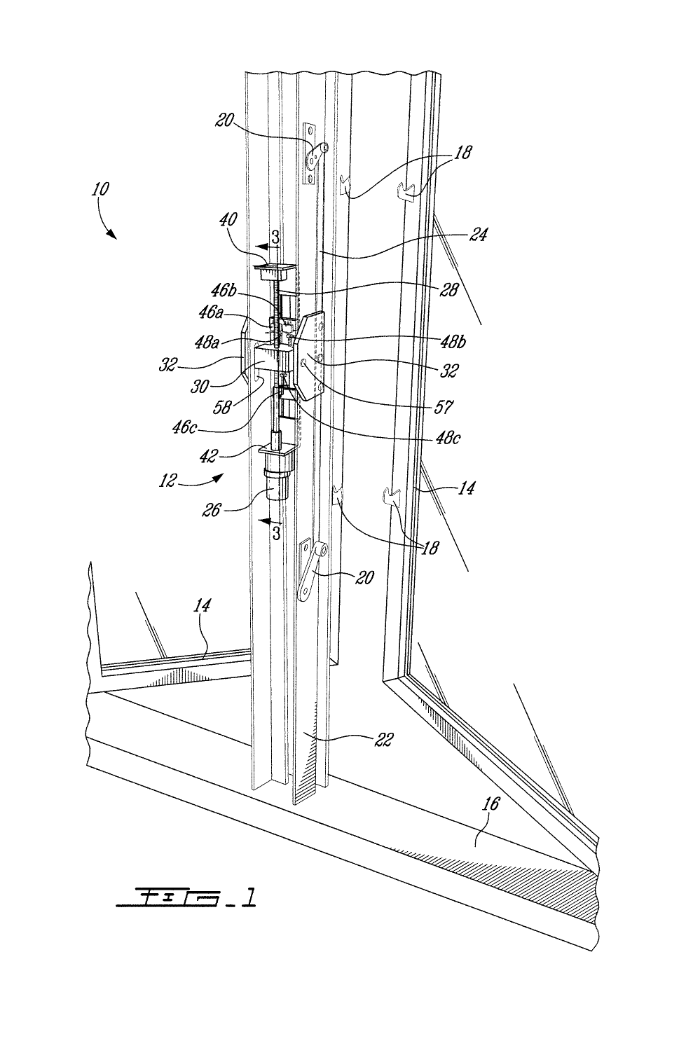

FIG. 1 illustrates a first example of a conventional casement window 10 to which a motorized latching system or operator 12 can be integrated or retrofitted to provide for motorized latching and unlatching of the window. The illustrated exemplary casement window 10 is of conventional double hung casement type comprising a pair of window sashes 14 hingedly mounted in a casement 16 for pivotal movement between open and closed positions about mobile vertical axes at opposite sides of the casement 16.

The casement window 10 is provided with latching hardware to releasably secure the window sashes 14 in their closed position. The latching hardware can comprise a plurality of keepers 18 (two in the illustrated example) on each window sash 14 for engagement with corresponding attachment points or latches 20 mounted on opposed longitudinal exterior sides of the central profiled post 22 of the casement 16. The latches 20 capture the keepers 18 and operation of the latches 20 draw the corresponding window sash 14 into its closed position where it is locked. In the closed position, the window sash 14 is seated in the frame and compresses weather stripping (not shown) to seal the window assembly. In the illustrated example, the latches of each set of latches 20 are interconnected by a latch bar 24 adapted to transmit the movement from one latch to another, thereby allowing for joint operation of the latches 20 of a same set. The latch bars 24 are typically made from flat steel strips mounted for linear sliding movement against the exterior longitudinal sides of the central profiled post 22 of the casement 16.

Instead of manually actuating the interconnected latches 20 via a conventional lever or handle provided at one of the latching points on each side of the central profiled post 22, it is herein proposed to nest a power-operated or motorized latch actuator system 12 in an existing frontal opening defined in the central profiled post 22 and to connect the system 12 directly to the existing latch bars 24 on each side of the central profiled post 22. Once installed, the motorized system 12 is hidden behind the front moulding (not shown) normally covering the post 22 when viewed from inside the room in which the window is mounted. By taking advantage of the existing free internal space offered by the central profiled post 22, it is possible to completely conceal the system 12 within the window casement 16, thereby preserving the overall appearance of the window.

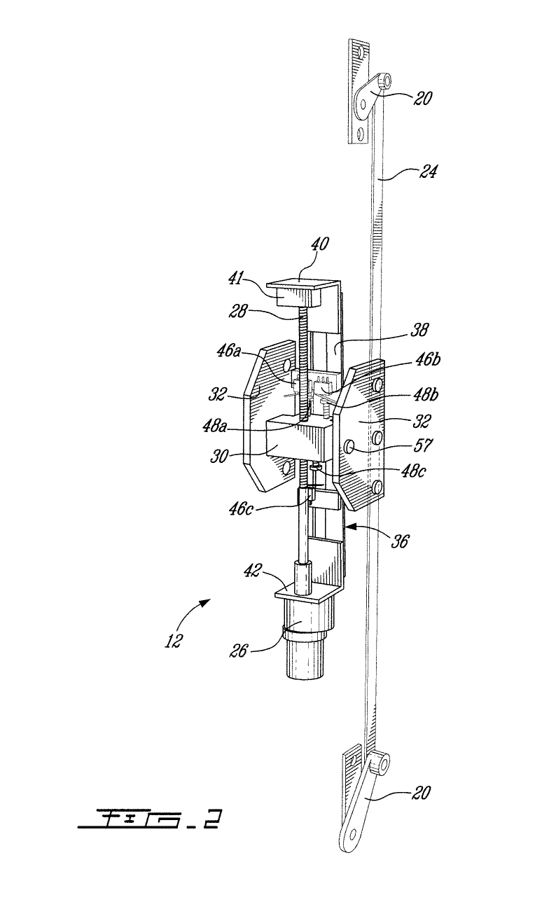

As best shown in FIG. 2, the system 12 generally comprises at least one reversible actuator, such as electrical reversible rotary motor 26, a push and pull rod which can take the form of a lead screw 28 drivingly connected to the motor 26, a slider 30 threadably engaged on the lead screw 28 for linear movement within the profiled post 22 (FIG. 1) in the upward and the downward directions, and a pair of link plates 32 mounted to opposed sides of the slider 30 in order to rigidly connect the slider 30 to the lock bars 24 of the window 10. An example of a suitable actuator is the 12 DVC E Type Inline DC Gearmotor Model No. 8501 manufactured by Merkle-Korff Industries. The dimensions of the selected actuator must allow the same to be fully contained within the central profiled post 22. The motor 26 is connected to a source of power (not shown), such as a battery. The lead screw 28 can consist of a stainless steel screw with ACME threads. The slider 30 can be manufactured in a block of polytetrafluoroethylene or from another solid block of low friction material in order to minimize the friction between the lead screw 28 and the slider 30.

The system 12 further comprises a support 36 for supporting the motor 26 and the lead screw 28 and facilitating mounting of the system 12 within the central profiled post 22 of the casement window. The support 36 comprises an elongated back 38 and top and bottom L-shaped plates 40 and 42 mounted at opposed ends of the elongated back 38. The elongated back 38 provides a mounting surface for fixedly mounting the system 12 into central profiled post 22 of the casement 16.

Holes can be defined through the back of the support 36 for receiving mounting screws or the like. The motor 26 is mounted to the undersurface of the bottom L-shaped plate 42. A support block 41 having a screw receiving hole depends from the top L-shaped plate 40 for receiving a tip end portion of the lead screw 28. Limit switches 46a, 46b and 46c are mounted to the front face of the support back 38 above and below the slider 30. Projections 48a, 48b, 48c, such as screws, are provided on the top and bottom surfaces of the slider 30 to trigger the limit switches 46a, 46b and 46c when the slider 30 reaches its top and bottom travel limits. The limit switches 46a, 46c are operatively connected to the motor 26 to shut down the same and reverse the direction of movement once triggered by a corresponding one of the triggering projections 48a, 48c, thereby defining the range of motion or stroke of the slider 30 on the lead screw 28. The third limit switch 46b is used as an interlock. The limit switch 46b is provided to prevent the motor (not shown) used to displace the window sashes 14 between their open and closed positions from being operated when the latches 20 are engaged with the keepers 18. It is provided to “sense” the lock state of the window sashes. It can also be used to prevent the motor 26 of the power operated latching system from being operated when the window sashes are opened.

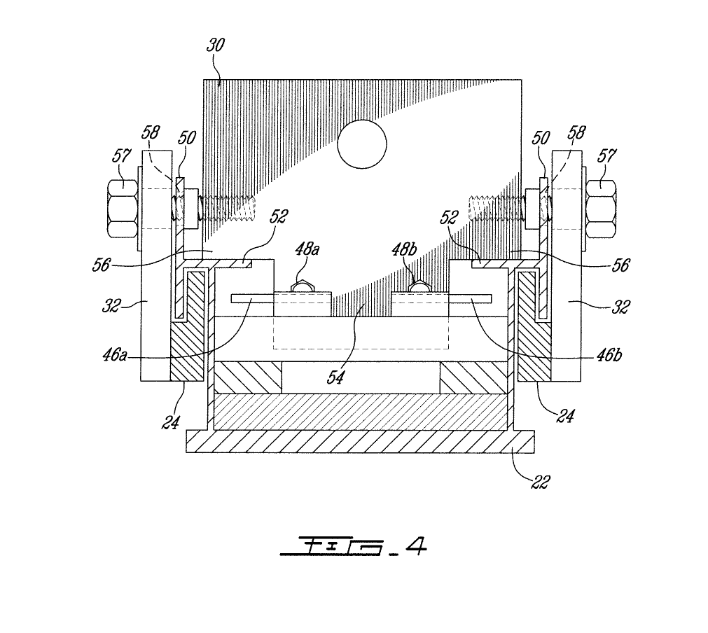

The motor 26, the lead screw 28, the slider 30, the support block 44 and the limit switches 46a, 46b, 46c are pre-assembled on the support 36 and this sub-assembly is mounted within the central profiled post 22, such as by screwing the support back 38 to a corresponding back surface of the casement window central profiled post 22 . As shown in FIG. 4, the central post 22 is provided in the form of an extrusion having a generally C-shaped profile with a front open face. The central post 22 has a frontal recess defined by sidewall surfaces 50 and inwardly projecting frontal wall surfaces 52. The slider 30 has a generally T-shaped body including a rearwardly projecting shank portion 54 and lateral shoulders 56. The shank portion 54 is received between the frontal wall surfaces 52 of the profiled post 22 with the lateral shoulders 56 resting against a front side of the frontal wall surfaces 52 between said sidewall surfaces 50. This arrangement prevents the slider 30 from rotating together with the lead screw 28. The slider 30 is thus constrained to move linearly in the upward or the downward direction depending whether the motor 26 is rotatably driving the lead screw 28 in the clockwise or the counter-clockwise direction.

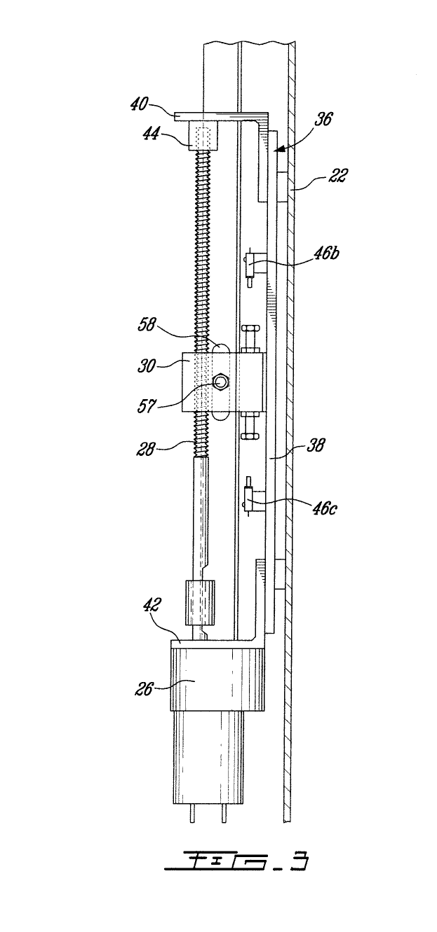

Still referring to FIG. 4, it can be appreciated that the lock bars 24 interconnecting the latches 20 (FIG. 1) are guided in vertical tracks defined at the outer sides of the central profiled post 22. The link plates 32 are positioned laterally outwardly from the sidewall surfaces 50 of the post 22 and are fixedly attached to the lock bars 24 by fasteners such as screws or the like. Vertically elongated slots 58 had to be machined (also see FIG. 3) in the post sidewall surfaces 50 for allowing the link plates 32 to be rigidly connected to the slider 30 by means of shoulder screws 57. In this way, the linear movement of the slider 30 inside the post 22 can be simultaneously transmitted to both latch bars 24 on the opposed sides of the central profiled post 22. The length of the elongated slots 58 is selected to accept the full stroke of the slider 30 as set by the position of the limit switches 46.

In use, a remote control can be used to operate the system 12. A wireless control receiver (not shown) can be mounted in the building wall underneath the window frame for receiving control commands and transmitting same to the electric motor 26. The rotational movement of the lead screw 28 causes the linear displacement of the slider 30 which in turn push or pull on the lock bars 24 (depending in which direction the screw is rotated) to actuate the latches 20 in order to lock or unlock the window.

If more torque is required to operate the latches, a second motor and a second lead screw could be added to the above described latch operator assembly. The second motor could be mounted to the top L-shaped plate 40 of the support with the second lead screw laterally offset with respect to the first lead screw 28. The motors would be synchronized but operated to drive the first and second lead screws in opposed directions.

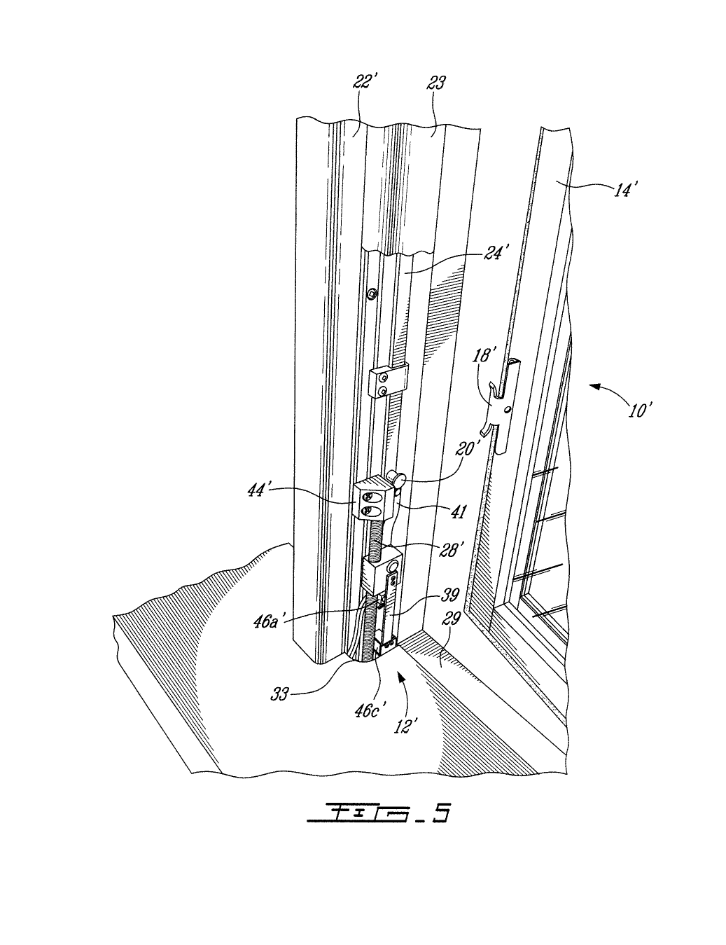

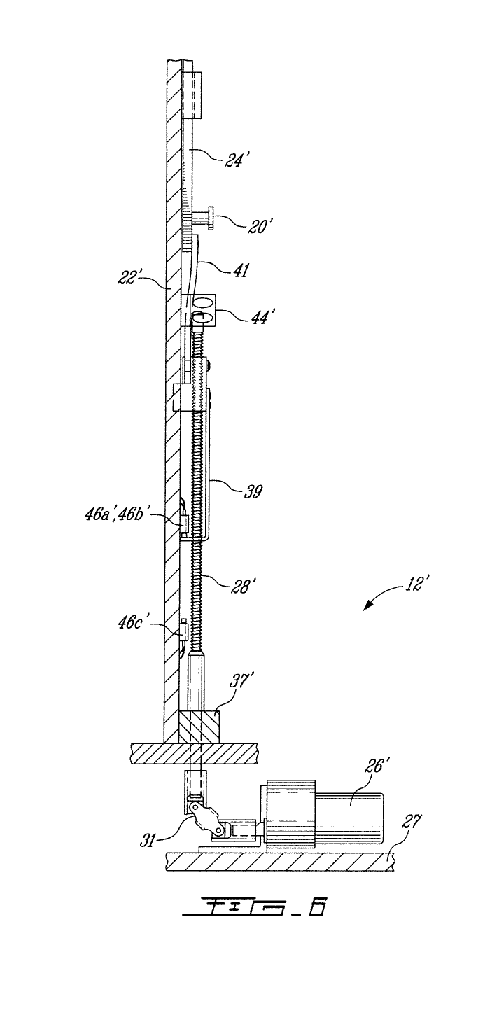

FIGS. 5 and 6 illustrate another example of the integration of a motorized latch actuation system 12′ to a double hung type casement window 10′ but this time for a model of window having a solid central post 22′ having no internal cavity in which the above described components of the motorized latching system could potentially be mounted. The only space available to access the lock bars 24′ is the ¾ inch to 1 inch gap existing between the central post 22′and the vertical moulding 23 on each side of the post 22′. This does not leave enough room to accommodate the motor.

The motor 26′ had thus to be disposed in a rectangular wooden box or casing 27 mounted to the casement 16′ underneath sill 29. The casing 27 forms a hollow window frame extension for receiving window operator equipment and the like. The motor 26′ is thus concealed in the building wall below the original window frame. The dimensions of the casing 27, notably the height thereof, are greatly limited by the presence of the structural or skeleton members of the building wall in which the window is mounted. In view of the small space available underneath the casement window 10′, the motor 26′ is horizontally disposed in the casing 27 and a universal joint 31 is used to connect the motor 26′ to the lead screw 28′ extending vertically along the side of the central post 22′ in the gap defined between the side moulding 23 and the central window post 22′.

The lead screw 28′ extends through a hole 33 defined in the window sill 29 and is vertically supported by a bottom support block 37 mounted to the central post 22′ underneath the sill of the window 10′. As shown in FIG. 6, the lead screw 28′ has a shoulder resting on top of the bottom block 37 to prevent the screw 28′ from sliding downwardly under gravity into the lead screw passage defined in the bottom block 37. The upper end or tip of the lead screw 28′ is received in a hole defined in a top support 44′ screwed or otherwise secured to the side of the central post 22′. The top support 44′ is also contained in the gap between the post 22′ and the moulding 23.

The limit switches 46a′, 46b′ and 46c′ are also directly mounted to the side of the post 22′ below the internally threaded slider 30′ mounted on the lead screw 28′ in the gap between the post 22′ and the moulding 23. A L-shaped triggering finger 39 extends downwardly from the slider 30′ for triggering the limit switches 46a′, 46b′ and 46c′ when the slider 30′ reaches the end of its stroke.

The mounting of the slider 30′ against the side wall of the central post 22′ locks the slider 30′ against rotation and constrains the slider 30′to move linearly along the side wall of the post 22′ in response to the rotation of the lead screw 28′. An elongated strip or rod 41 extends upwardly from a post facing side of the slider 30′ in order to rigidly connect the same to the existing lock bar 24′ interconnecting the latches 20′ of the window 10′. The linear movement of the slider 30′ on the lead screw 28′ can thus be transferred to the existing lock bar 24′ in order to latch and unlatch the window.

It is understood that a similar motorized latch operator is provided on the other side of the central post to operate the lock bar interconnecting the latches associated to the second window sash (not shown).

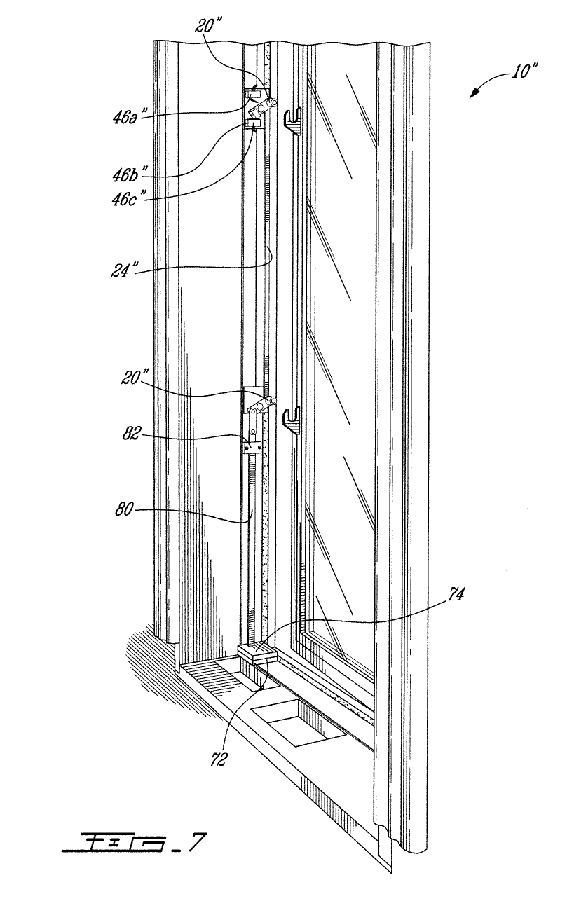

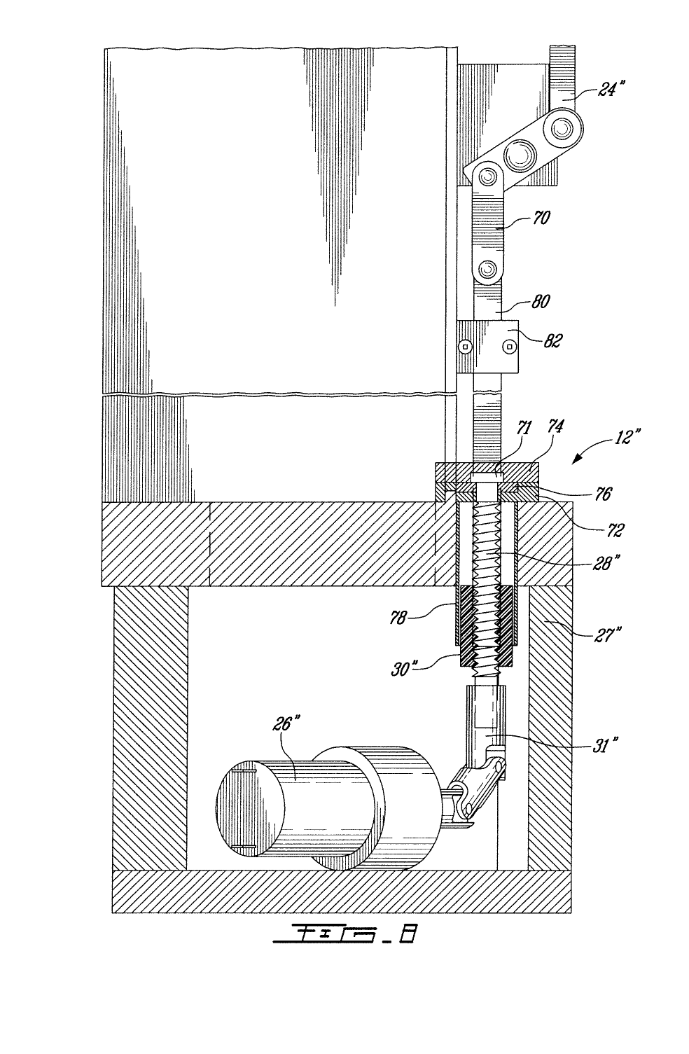

FIGS. 7 and 8 illustrate another example of the integration of a motorized latch actuation system 12″ to an originally manually actuated latching system of a single hung type casement window 10″. In this example, the window lock bar 24″ interconnecting the latches 20″ on one side of the window frame is disposed further towards the outside of the room in which the window is mounted. The casing 27″ secured underneath the window frame in the building wall and holding the motor 26′ is not aligned with the lock bar 24″. The casing 27″ is located further towards the inside of the room relative to the lock bar 24″. As will be seen herein after, this misalignment problem is overcome by connecting the motorized system 12″ to an existing link 70 originally joined to the lever/handle (not shown) of the lower manual latch 20″.

As shown in FIG. 8, the motor 26′ is horizontally mounted in casing 27″ which is disposed in the building wall underneath the window frame. The motor 26″ is drivingly connected to a vertically disposed lead screw 28″ via universal joint 31″. The lead screw 28″ extends through a hole defined in the window sill and has a top head 71 retained captive between a base 72 and a cover 74. The base 72 and the cover 74 are made of a low friction material and are used to support the lead screw 28 “in position. The base 72 is mounted on a top surface of the window sill and has a through bore defined therein for allowing the lead screw 28” to pass therethrough. A recess is defined in a top surface of the base 72 for receiving a split washer 76. The washer 76 is mounted about the lead screw 28″ underneath head 71. The cover 74 has a recess defined in an undersurface thereof for accommodating the screw head 71 and is screwed or otherwise suitably secured to the base 72. A horizontal moulding (not shown) covers the sill of the window to conceal the base 72 and the cover 74.

A low frictional material rectangular sleeve 78 is installed in the hole defined in the window sill to provide for smoothly guided movement of slider 30″ on the lead screw 28″. The sleeve 78 is configured to lock the slider 30″ against rotation while providing for smooth linear gliding movement therein. An elongated flattened rod or strip 80 is attached to the slider 30″ and extends vertically upwardly through aligned slotted holes defined in the base 72 and cover 74. The upper end of the strip 80 is pivotally connected to existing link 70 which is, in turn, connected to the lock bar 24″ joining all the latches 20″ of the window. The pull and push strip 80 can be guided at the upper end thereof by a guide 82 mounted to the side member of the window frame on which the latches 20″ are mounted. The vertical moulding (not shown) of the side member of the window frame conceal all the mechanism disposed therealong.

As shown in FIG. 7, the limit switches 46a″, 46b″, 46c″ are mounted on the side of the frame next to the upper latch 20″ so as to be triggered by the components thereof.

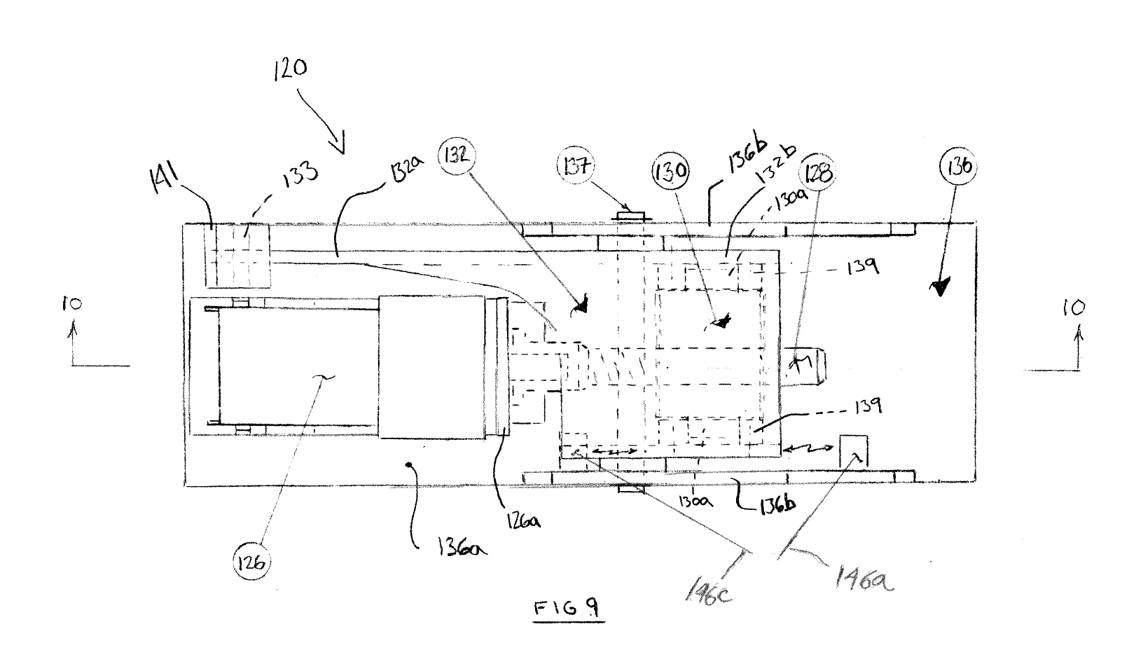

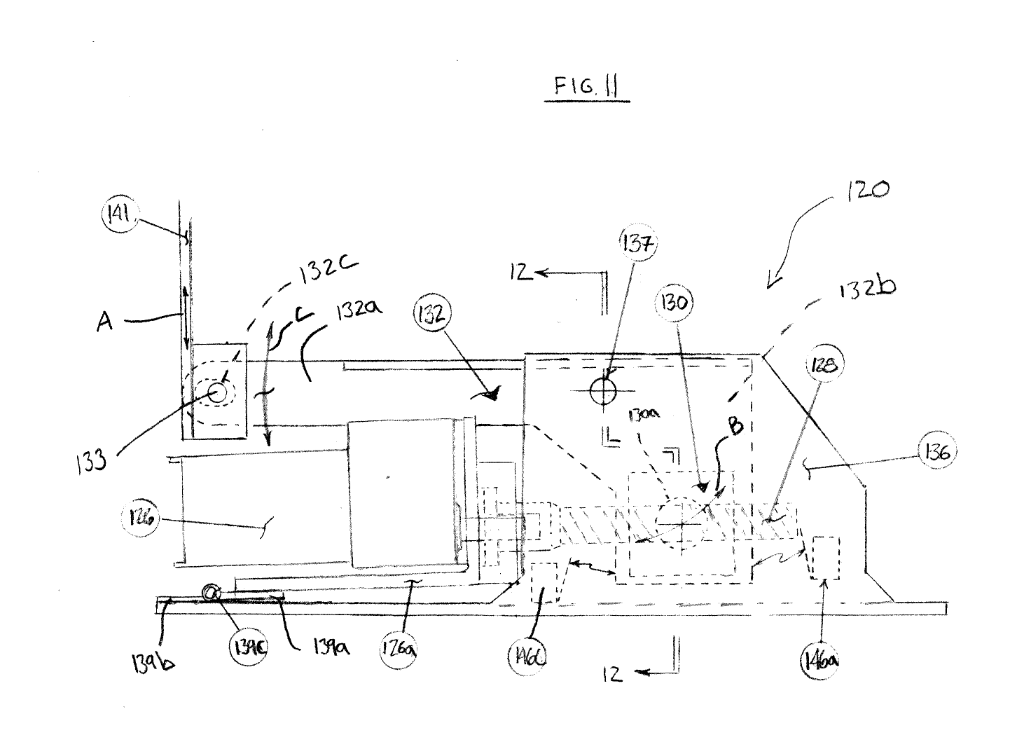

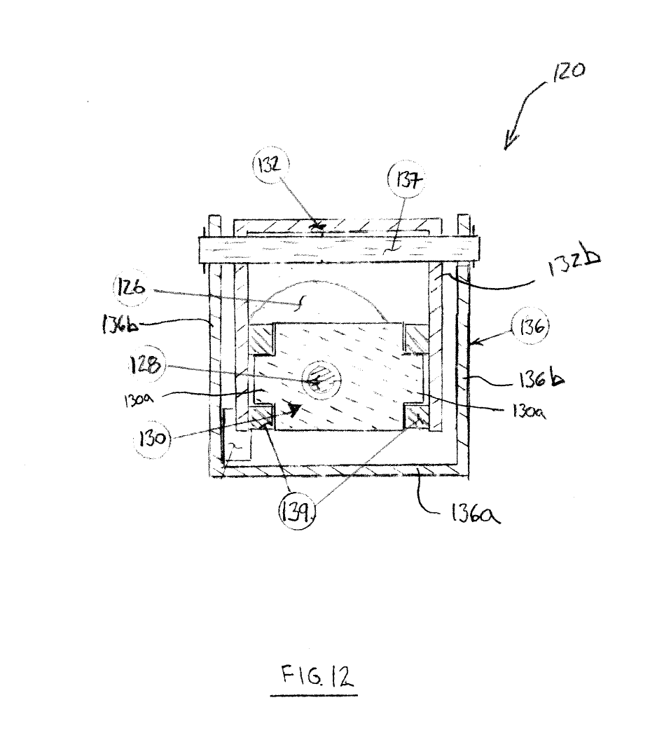

FIGS. 9 to 12 illustrate another example of a motorized latch actuation system 120 adapted to be mounted in a hollow casing (not shown) secured underneath a window frame in a building wall. The system 120 comprises a support frame 136 including a base plate 136a adapted to be screwed or otherwise suitably securely mounted to the bottom wall of the casing underneath the window frame. The support frame 136 further comprises a pair of side plates 136b extending integrally upwardly from the base plate 136a. A lever 132 is pivotally mounted to side plates 136b for rotation about a generally horizontal axle 137 extending transversely through the side plates 136b and the lever 132. The lever 132 has an arm portion 132a projecting away from one end of an inverted U-shaped end portion 132b mounted between the side plates 136b of the support frame 136. The side plates 136b and the U-shaped end portion 132b have registering holes for receiving the axle 137. The distal end of the arm portion 132a of the lever 132 has an elongated slot 132c (FIG. 11) adapted to receive a fastener 133 for pivotal connection to a latch bar extension 141 adapted to be rigidly connected to bottom end of the latch bar (not shown) of the window. In this way, the lever 132 can be rotated about the axle 137 to linearly displace the latch bar extension 141 and, thus, the latch bar in an upward or a downward direction (see arrows A in FIG. 11) in order to lock or unlock the window. The length of the arm portion (distance between the axle 137 and the elongated slot 132c) is selected to provide the desired levering force.

As best shown in FIGS. 9 and 11, a pair of low friction pads 139 is fixedly mounted to the inwardly facing side of the U-shaped end portion 132b of the lever 132 for engagement with a slider 130 which is, in turn, threadably engaged on a lead screw 128 driven by a reversible rotary motor 126. The slider 130 is trapped between the low friction pads 139 and has cylindrical projections 130a extending laterally therefrom for engagement in corresponding cylindrical holes defined in the pads 139. This arrangement allows for relative angular movements between slider 130 and the pads 139 (and, thus, the lever 132) when the slider 130 moves along the lead screw 128 in response to a torque being applied thereto by the motor 126. The distance between the cylindrical projections 130a of the slider 130 and the pivot axis of the lever (i.e. the axle 137) is also selected as a function of the desired levering force for operating the latch bar.

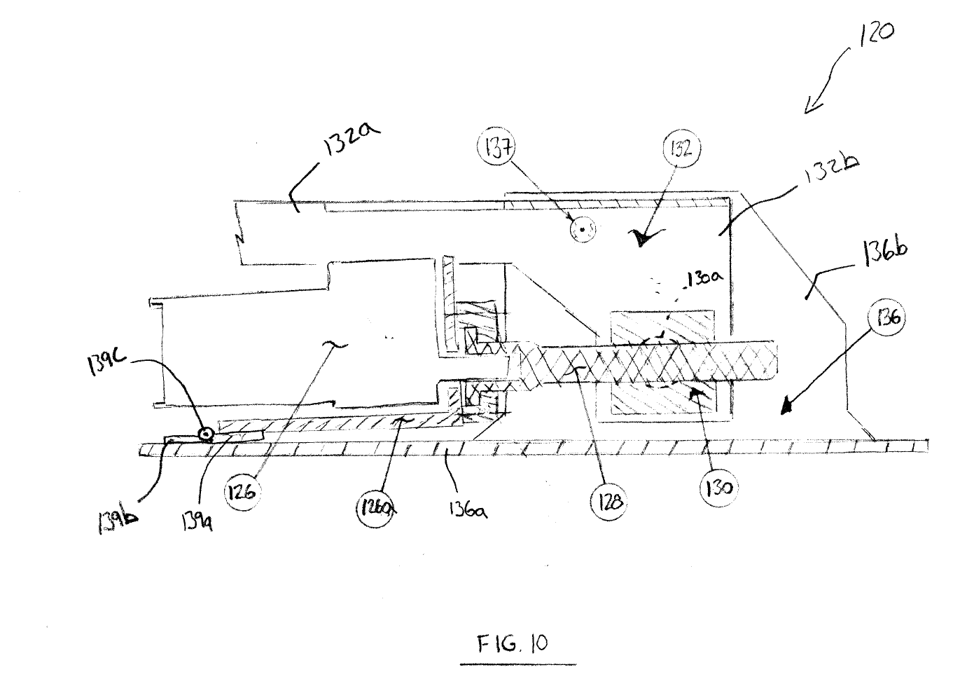

As shown in FIGS. 10 and 11, the motor 126 is mounted to a support 126a which is, in turn, hingedly mounted to the base plate 136a of the support frame 136. For instance, the support 126a may be rigidly connected to a first hinge plate 139a pivotally connected at 139c to a second hinge plate 139b fixed to the top surface of the base plate 136a at the rear end of the motor 126.

As shown in FIGS. 9 and 11, limit switches 146a and 146c are mounted to the inwardly facing surface of one of the side plates 136b of the support structure 136 and are disposed to be triggered by the inverted U-shaped portion 132b of the lever 132 when the same is pivoted by the slider 132 to its limit positions on axle 137.

In operation, the motor 126 may be powered to linearly displace the latch bar of the window between locked and unlocked positions. The rotation of the lead screw 128 causes the slider 130 to move therealong, thereby causing the lever to pivot about axle 137 has indicated arrows B in FIG. 11. The hinge connection between the motor 126 and the support frame 136 allows to accommodate the pivotal movement of the lever 132 and, thus, of the slider 130 relative to the axle 137. As a result, the arm portion 132a of the lever 132 is pivoted as depicted by arrows C in FIG. 11 to upwardly or downwardly linearly displace the latch bar extension 141 together with the latch bar (not show) connected thereto.

It is understood that the arm portion 132a of the lever could extend in a direction opposite to the direction illustrated in FIGS. 9 to 11. That is the arm portion 132a could extend axially in a direction away from the motor 126 forwardly relative to the lead screw 128. The forwardly or rearwardly projecting configuration may be selected depending on the space available in the hollow casing underneath the window frame.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

What is claimed is:

1. A motorized latch operator adapted to be retrofitted to a normally manually operated latching assembly of a casement window mounted in a building wall, the casement window having at least one window sash hingedly mounted in a casement for pivotal movement about a vertical axis between open and closed positions, keepers being provided along one side of the window sash for engagement with corresponding latches mounted on a vertical side frame member of the casement, the latches being operatively interconnected by a vertical latch bar mounted for longitudinal movement in a gap defined between the side frame member and a moulding member; the motorized operator comprising a support frame mounted in a casing integrated to a building wall next to the casement, a reversible rotary motor hingedly mounted to the support frame, a lead screw drivingly connected to the reversible rotary motor, a slider threadably engaged on the lead screw for movement therealong, a lever pivotally mounted at a first end portion thereof to the support frame, the slider being engaged with the lever to pivot the same in response to a movement of the slider along the lead screw, the lever being pivotally connectable at a second end portion thereof to the vertical latch bar to linearly displace the same when pivoted as a result of the movement of the slider on the lead screw.

2. The motorized latch operator defined in claim 1, wherein the support frame has a base plate, wherein a first hinge plate is secured to said base plate, a second hinge plate is pivotally connected to said first hinge plate for pivotal movement towards and away from the base plate, and wherein the reversible rotary motor is mounted to said second hinge plate.

3. The motorized latch operator defined in claim 1, wherein the slider has a pair of cylindrical projections extending laterally therefrom, the cylindrical projections begin received in corresponding holes of said lever.

4. The motorized latch operator defined in claim 1, wherein the slider has travel limits set by limit switches mounted to said support structure.

5. The motorized latch operator defined in claim 1, wherein the lever has an arm portion extending in a direction opposite to said lead screw, said arm portion having an elongated slot defined in a distal end thereof for connection with a latch bar extension adapted to be fixedly connected to the latch bar.

6. The motorized latch operator defined in claim 1, wherein the lever has an arm portion which extends axially in a same direction as that of said lead screw.

7. The motorized latch operator defined in claim 1, wherein the casing is mountable underneath a sill of the casement in the building wall.

8. A power-operated latch assembly for a casement window mounted in a building wall, the casement window having at least one window sash hingedly mounted in a window frame for pivotal movement about a vertical axis between open and closed positions; the power-operated latch assembly comprising at least two keepers mounted to the window sash for locking engagement with corresponding latches operated by a latch bar mounted for vertical movement along one vertical member of the window frame, a reversible operator mounted to a support frame disposed in the building wall adjacent to the casement window, a lever pivotally mounted to the support frame and having a first end drivingly connected to said reversible operator and a second end pivotally connected to the latch bar, the pivotal movement of the lever by the reversible operator causing the linear movement of the latch bar.

9. The power-operated latch assembly defined in claim 8, wherein the reversible operator comprises a rotary motor, a lead screw driven by the rotary motor, and a slider threadably engaged on the lead screw, and wherein the rotary motor is pivotally mounted to the support frame.

10. The power-operated latch assembly defined in claim 8, wherein the support frame has a base plate, wherein a first hinge plate is secured to said base plate, a second hinge plate is pivotally connected to said first hinge plate for pivotal movement towards and away from the base plate, and wherein the reversible operator is mounted to said second hinge plate.

11. The power-operated latch assembly defined in claim 9, wherein the slider has a pair of cylindrical projections extending laterally therefrom, the cylindrical projections begin received in corresponding holes on said lever.

12. The power-operated latch assembly defined in claim 9, wherein the slider has travel limits set by limit switches mounted to said support structure.

13. The power-operated latch assembly defined in claim 9, wherein the lever has an arm portion extending in a direction opposite to said lead screw, said arm portion having an elongated slot defined in a distal end thereof for connection with a latch bar extension adapted to be fixedly connected to the latch bar.

14. The power-operated latch assembly defined in claim 1, wherein the lever has an arm portion which extends axially in a same direction as that of said lead screw.
